(19) United States
(12) Patent Application Publication
(10) Pub. No.: US 2015/0266116 A1
(43) Pub. Date: Sep. 24, 2015

(54) LATERALLY SLIDING SAW

(71) Applicant: Greenlee Textron Inc., Rockford, IL (US)

(72) Inventor: Brandon Lorenzo Slack, Rockford, IL (US)

(21) Appl. No.: 14/222,788

(22) Filed: Mar. 24, 2014

(51) Int. Cl. B23D 45/04; B23D 47/06; B23D 59/00

(52) U.S. Cl. CPC B23D 45/046; B23D 59/007; B23D 47/06

(57) ABSTRACT

An assembly includes a table, a saw for cutting an associated workpiece, and a mount upon which the saw is mounted. The table has a length which is greater than its width. The saw has a blade which defines a cutting direction which is normal relative to the length of the table. The saw is mounted to the mount, and the mount is mounted to the table. The mount and saw translate laterally along the table in a direction parallel to said length of said table and normal to the cutting direction.

### FIELD OF THE INVENTION

The present invention relates to a laterally sliding saw, which moves in a direction normal to the cutting direction, but parallel to the lengthwise direction of a linear workpiece to be cut.

### BACKGROUND OF THE INVENTION

Methods for cutting material in a limited space include compact table saws. With these methods, the material is moved relative to the saw. For example, if the table saw is used to cut a 10 foot long conduit, but only 1 foot is needed to be cut off, then the operator will need 9 foot of space proximate to the table without any obstructions. If there is limited space on both sides of the table upon which the saw is mounted, and a long material is being cut, there can be obstructions that do not allow material move freely.

A laterally slidable saw is provided herein which provides improvements to the existing prior art and which overcomes the disadvantages presented by the prior art. Other features and advantages will become apparent upon a reading of the attached specification, in combination with a study of the drawings.

### SUMMARY OF THE INVENTION

An assembly includes a table, a saw for cutting an associated workpiece, and a mount upon which the saw is mounted. The table has a length which is greater than its width. The saw has a blade which defines a cutting direction which is normal relative to the length of the table. The saw is mounted to the mount, and the mount is mounted to the table. The mount and saw translate laterally along the table in a direction parallel to said length of said table and normal to the cutting direction.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a perspective view of a table having a laterally sliding saw mounted on a mount which is, in turn, mounted on the table, which incorporates the features of the present invention;

FIG. 2 is a top elevation view of the table;

FIG. 3 is a perspective view of a portion of the table showing a portion of the assembly for holding the workpiece on the table;

FIG. 4 is a perspective view of a portion of the table with the workpiece mounted thereon;

FIG. 5 is another perspective view of a portion of the table with the workpiece mounted thereon;

FIG. 6 is a perspective view of the saw and the mount, and of a rail of the table;

FIG. 7 is a top perspective view of the saw, the mount and the rail of the table;

FIG. 8 is a bottom perspective view of the saw and the mount (with the rail removed);

FIG. 9 is an end elevation view of the table, the saw and the mount;

FIG. 10 is an enlarged end elevation view of the table, the saw and the mount;

FIG. 11 is a cross-sectional view of the saw, the mount and the rail;

FIG. 12 is a perspective view of a portion of the table;

FIG. 13 is a top elevation view of a portion of the table;

FIG. 14 is a perspective view of a platform of the table; and

FIG. 15 is a perspective view of part of a marking system provided as part of the table.

### DETAILED DESCRIPTION OF THE ILLUSTRATED EMBODIMENTS

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein. Therefore, unless otherwise noted, features disclosed herein may be combined together to form additional combinations that were not otherwise shown for purposes of brevity.

A table 20 for marking and cutting a linear workpiece 22, such as conduit or rebar, is provided. The table has a saw 24 mounted on a slideable mount 26 which allows for multiple cuts to be made to the workpiece 22 without having to move the workpiece 22 relative to the table 20. A marking system 25 is provided for making at least one mark on the workpiece 22 to show where a cut or a bend (to be made by a conduit bender (not shown) after removal of the workpiece 22 from the table 20.

The mount 26 enables the saw 24 to slide laterally along the table 20 in order to cut the workpiece 22. In a situation where there is limited space for cutting the workpiece 22 with the saw 24, the mount 26 enables the saw 24 to be moved laterally along the length of the workpiece 22 to effect one or more cuts along the length of the workpiece 22. With the present invention, the workpiece 22 being cut is held stationary while the saw 24 is slid along the length of the workpiece 20 to cut at different locations along the workpiece 22. The sliding direction of the mount 26 is normal to the cutting direction of the saw 24, but parallel to the workpiece lengthwise, in order to allow the saw 24 to cut the workpiece 22.

Such saws 24 are well-known in the art and the specifics are not repeated herein. In general, the saw 24 includes a base 28 having a planar lower surface 28a, a housing 30 extending from an upper surface of the base 28, and a blade 32 mounted in the housing 30. The housing 30 and the blade 32 are pivotable relative to the base 28 so that the blade 32 can engage and cut the workpiece 22. The blade 32 defines the cutting direction.

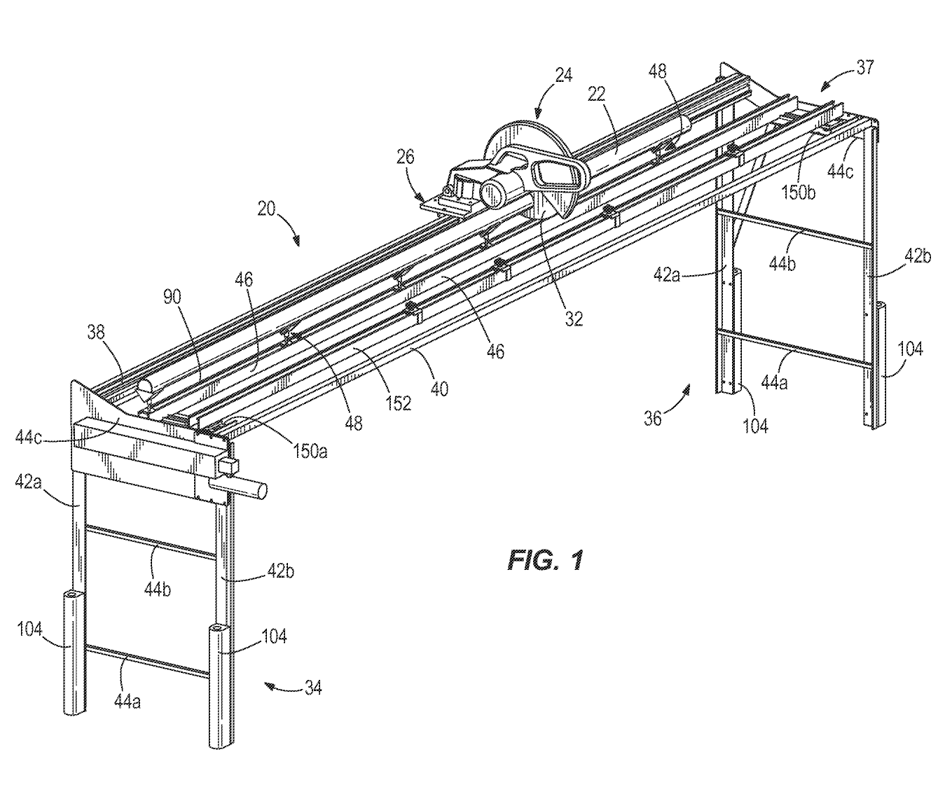

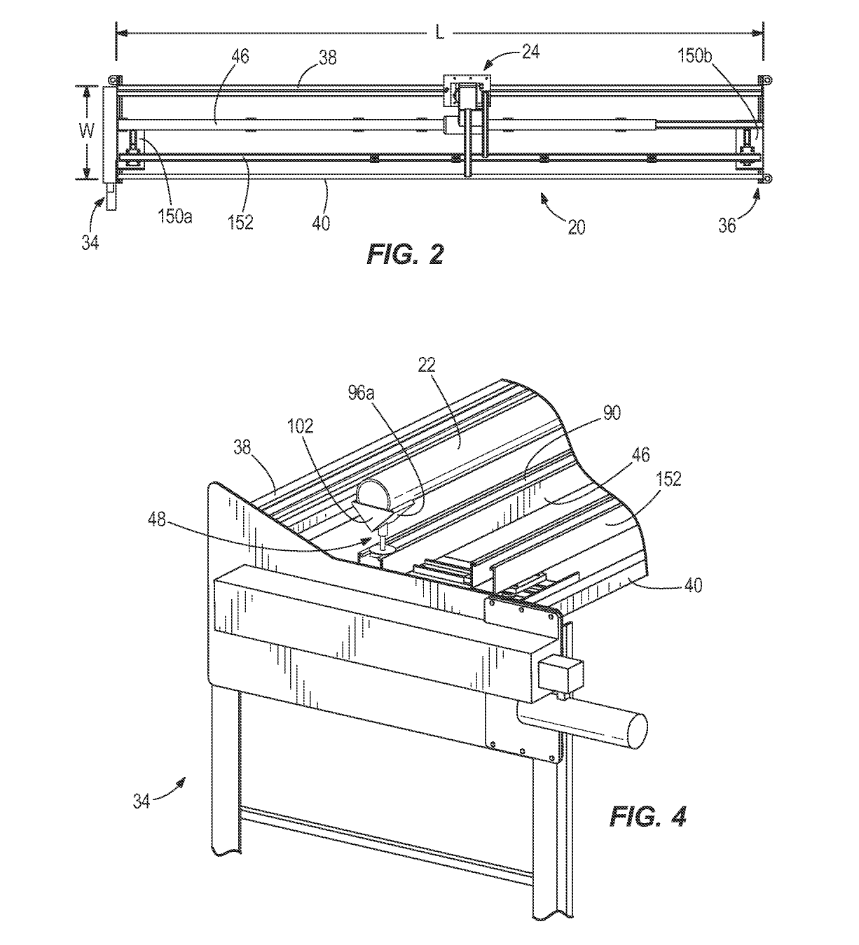

As best shown in FIG. 1, the table 20 has a first leg assembly 34, a second leg assembly 36, and a table top assembly 37. Each leg assembly 34, 36 includes a pair of vertical legs 42a, 42b which are connected together by spaced apart horizontal ribs 44a, 44b, 44c. The topmost rib 44c is provided at the upper ends of the legs 42a, 42b. The table top assembly 37 includes a first elongated rail 38 connecting a first end of each leg assembly 34, 36 together, a second elongated rail 40 connecting a second end of each leg assembly together 34, 36, and an elongated workpiece support rail 46 which extends between the topmost ribs 44a. The workpiece support rail 46 is spaced from the first rail 38. As such, a length L of the table 20 is defined along the length of the rails 38, 40, and a width W of the table 20 is defined along a direction normal to the rails 38, 40. In the present invention, it is critical that the length L of the table 20 is greater than the width W of the table 20 so that an elongate workpiece 26 can be held on the table 20 without overhanging the ends of the table 20 during the cutting process. Preferably the length L of the table 20 is at least two times greater than the width W of the table 20.

Each leg 42a, 42b has structure 104 for raising and lowering the table top assembly 37 relative to the stationary structure upon which the table 20 is mounted. This raising and lowering structure 104 may take the form of hydraulic lifts, telescoping legs, etc. Other structures for raising and lowering a member are known in the art and are within the scope of the present invention.

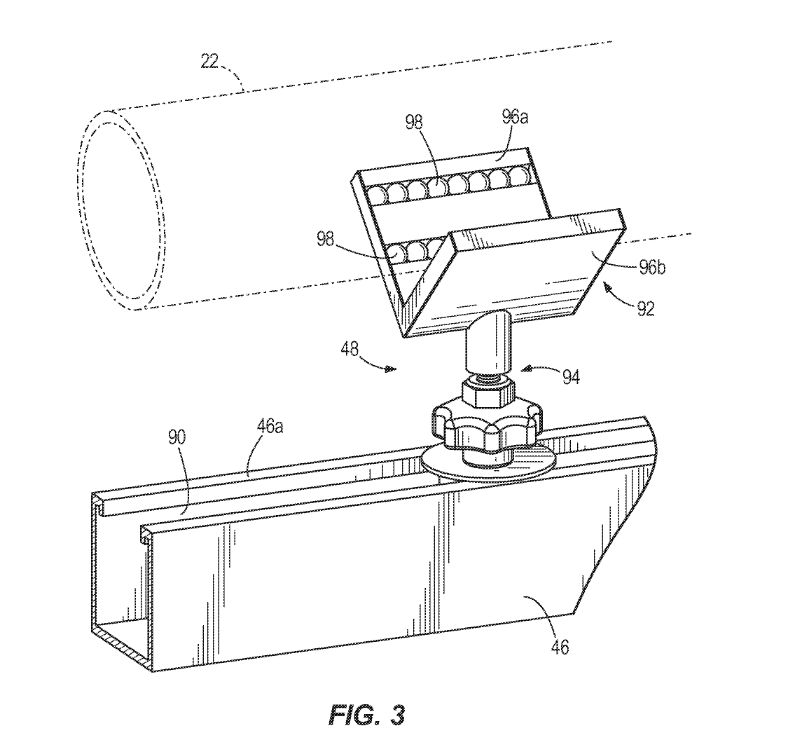

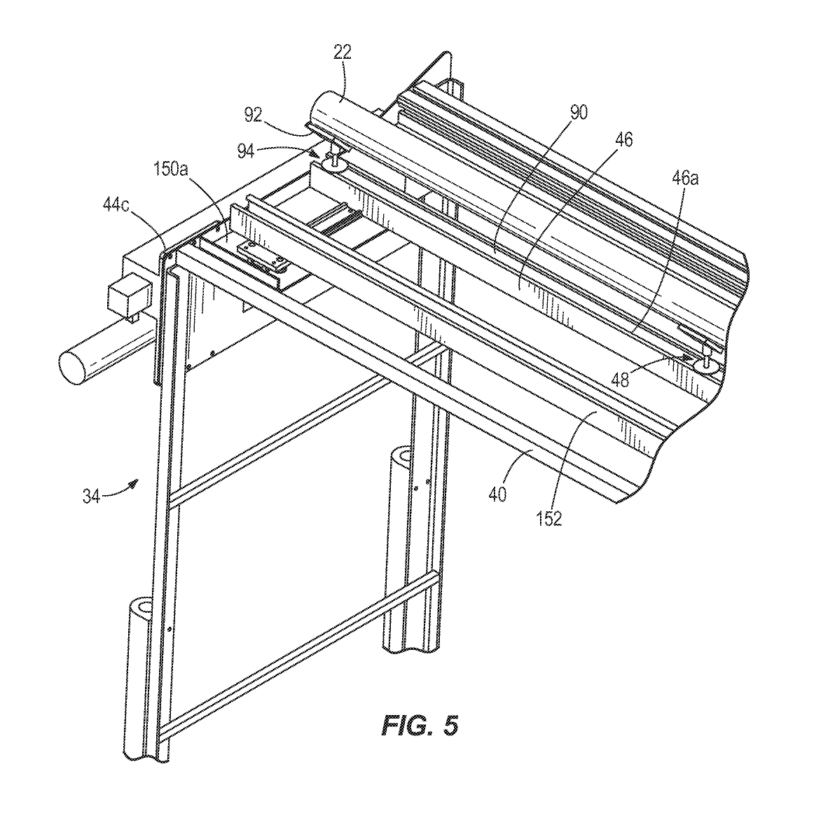

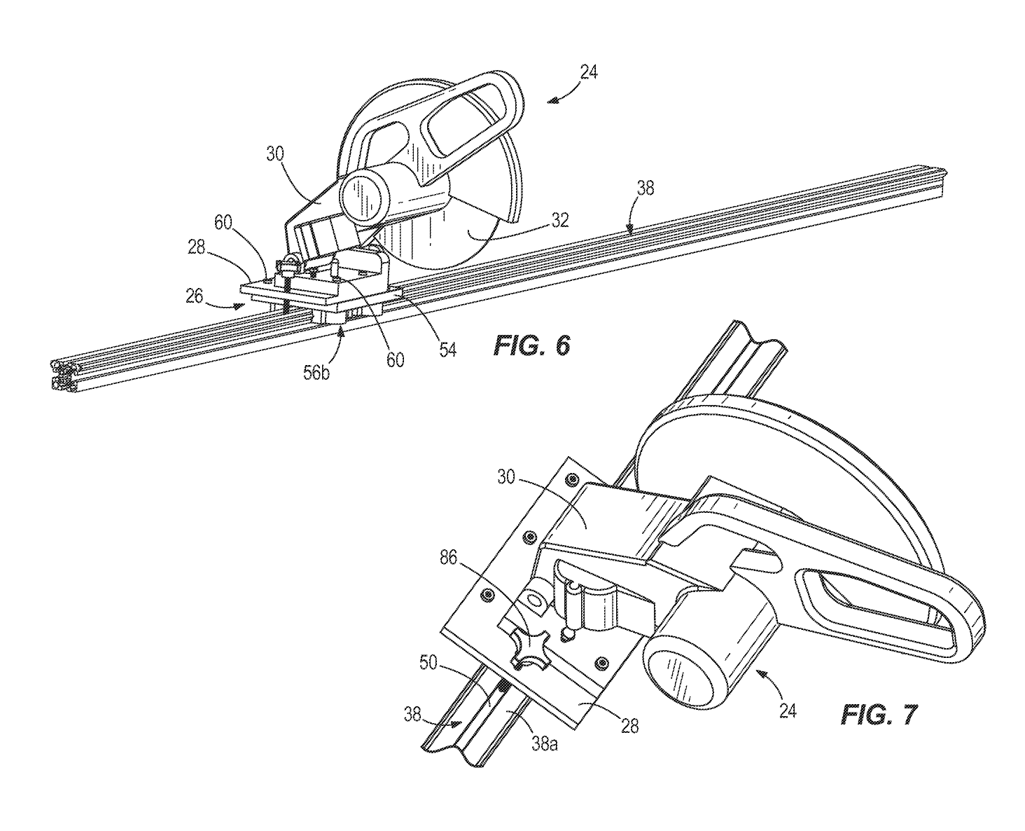

As best shown in FIGS. 1 and 3, the workpiece support rail 46 has an elongated slot 90 extending from its top surface 46a and which extends along the length of the workpiece support rail 46. A plurality of spaced apart workpiece holding brackets 48 are mounted in the slot 90 and extend upwardly from the top surface 46a of the workpiece support rail 46. The workpiece holding brackets 48 support the workpiece 22 along its length and elevate the workpiece 22 above the workpiece support rail 46. Each workpiece holding bracket 48 has a V-shaped block 92 upon which the workpiece 22 seats and a mounting assembly 94 for mounting the V-shaped block 92 to the workpiece support rail 46. The mounting assembly 94 can take a variety of forms and can be loosened to enable the workpiece holding bracket 48 to be moved along the workpiece support rail 46 and can be tightened to secure the workpiece holding bracket 48 in place relative to the workpiece support rail 46. The mounting assembly 94, when loosened, preferably does not change the angular position of the V-shaped block 92 relative to the workpiece support rail 46. The V-shaped block 92 of each workpiece holding bracket 48 has a pair of walls 96a, 96b which are angled relative to each other to form the “V”. Each wall 96a, 96b has a plurality of ball bearings 98 mounted in slots 100. This allows the workpiece 22 to rotate relative to the workpiece holding brackets 48. The workpiece holding bracket 48 which is provided proximate to leg assembly 34 has an end wall 102 at one end of the walls 96a, 96b. When the workpiece 22 is positioned on the workpiece holding brackets 48, the workpiece 22 abuts against the end wall 102, thereby preventing the lateral movement of the workpiece 22 relative to the table 20.

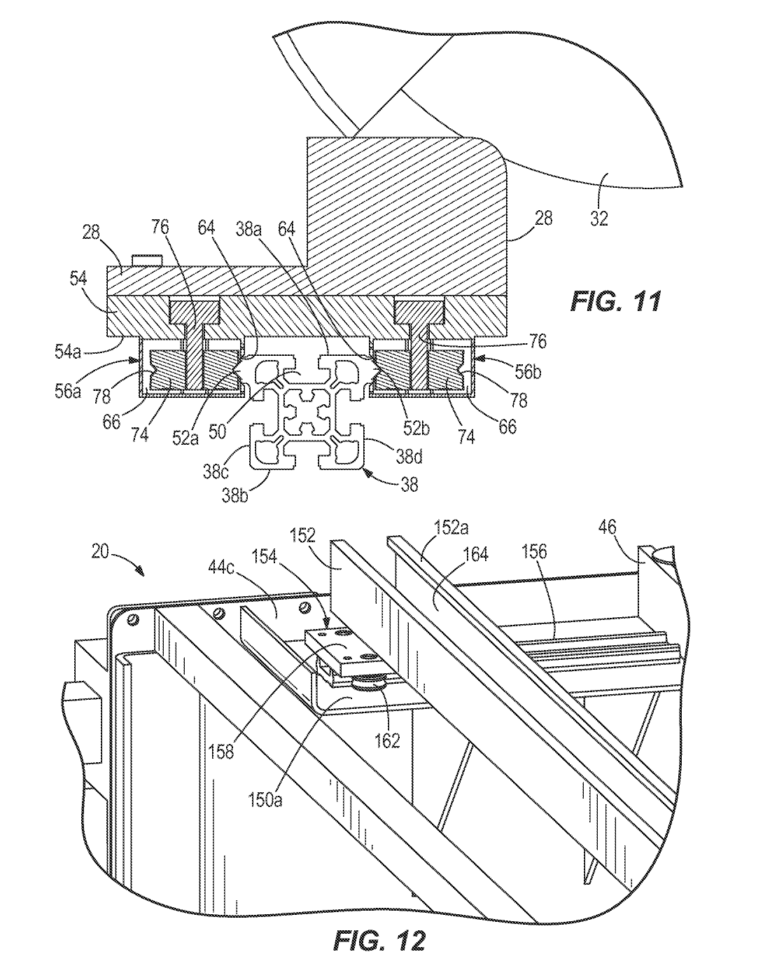

A cross-section of the elongated rail 38 is best shown in FIGS. 10 and 11. The rail 38 has a generally square cross-section having an upper surface 38a, an opposite bottom surface 38b, and side surfaces 38c, 38d connecting the upper and lower surfaces 38a, 38b together. Along at least the upper surface 38a of the rail 38, a slot 50 extends along the rail 38, preferably along the entire length of the rail 38. Each side surface 38c, 38d has an elongated protrusion 52a, 52b that extends outwardly from the side surface 38c, 38d along the rail 38, preferably along the entire length of the rail 38. Each protrusion 52a, 52b is preferably generally V-shaped in cross-section, but the protrusion 52a, 52b may take other forms. Preferably, each protrusion 52a, 52b is positioned proximate to the corner between the side surface 38c, 38d and the upper surface 38a.

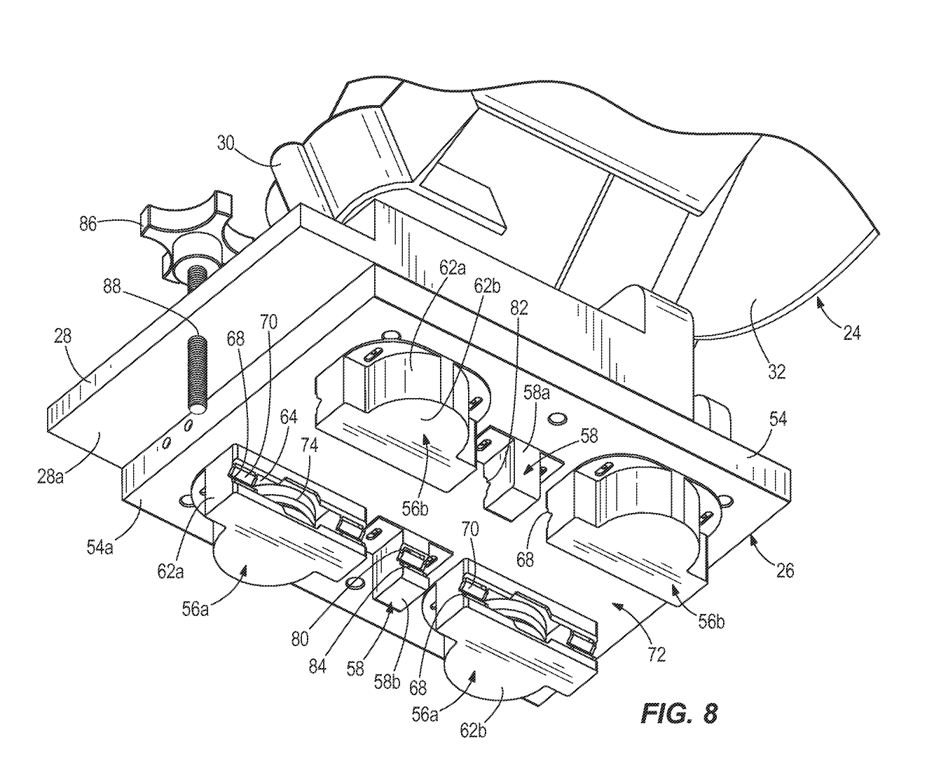

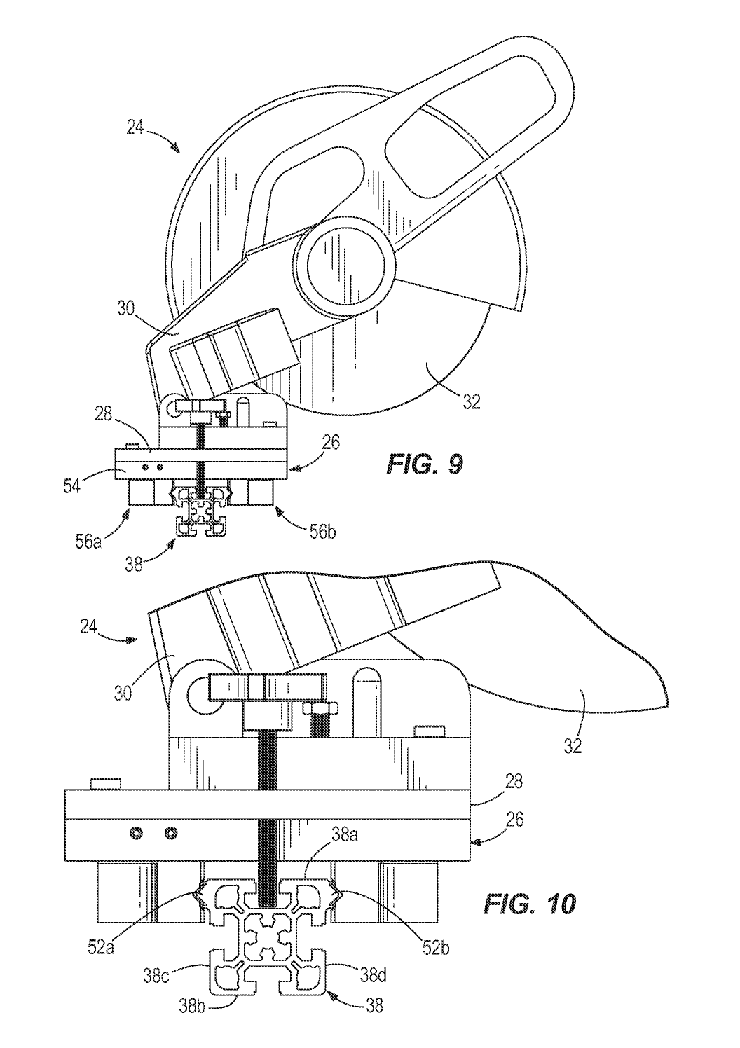

The mount 26 is best shown in FIGS. 7 and 8. The mount 26 has a planar base wall 54 having a plurality of wheel/bearing housings 56a, 56b extending downwardly from a lower surface 54a of the base wall 54, and slide pad housings 58 extending downwardly from the lower surface 54a of the base wall 54. The planar lower surface 28a of the base 28 of the saw 24 abuts against the planar upper surface 54a of the base wall 54. The base 28 of the saw 24 is attached to the base wall 54 by suitable means, such as fasteners 60.

Each wheel/bearing housing 56a, 56b has a side wall(s) 62a extending downwardly from the lower surface 54a of the base wall 54 and a bottom wall 62b closing the lower end of the side wall(s) 62a. The side and bottom walls 62a, 62b define a side opening 64 and an internal cavity 66. The edges of the side wall(s) 62a which define the side opening 64 have a groove 68 therein, which is preferably V-shaped. A slide pad 70, which preferably conforms to the shape of the groove 68, may be mounted in each groove 68. The wheel/bearing housing 56a, 56b are preferably located proximate to the corners of the base wall 54. The openings 64 of wheel/bearing housing 56a, 56b face each other such that a central passageway 72 is formed between the wheel/bearing housings 56a, 56b.

A wheel or bearing 74 is mounted in the cavity 66 and is capable of rotation relative to the wheel/bearing housings 56a, 56b. The wheel or bearing 74 is preferably rotatably mounted on a spindle 76 attached to the wheel/bearing housing 56a, 56b. The axis of rotation of the wheel or bearing 74 is normal to the lower surface 54a of the base wall 54. Each wheel or bearing 74 has a groove 78 in its outer surface which extends around the circumference of the wheel or bearing 74, which is preferably V-shaped.

Each slide pad housing 58 has a side wall(s) 58a extending downwardly from the lower surface 54a of the base wall 54 and a bottom wall 58b closing the lower end of the side wall(s) 58a. The side and bottom walls 58a, 58b define a side opening 80 and an internal cavity. The edges of the side wall(s) 58a which define the side opening 80 have a groove 82 therein, which is preferably V-shaped. A slide pad 84, which preferably conforms to the shape of the cavity and the groove 82, is mounted in each cavity. One slide pad housing 58 is positioned between one set of the wheel/bearing housings 56a, 56b and another slide pad housing 58 is positioned between the other set of the wheel/bearing housings 56a, 56b and the side opening 80 face each other and form part of the central passageway 72.

The mount 26 is mounted on the rail 38 by sliding the mount 26 over the end of the rail 38. The protrusions 52a, 52b on the rail 38 seat within the grooves 78 in the wheels/bearings 74. The protrusions 52a, 52b may engage the slide pads 70, 84. The rail 38 is then formed with the remainder of the table 20. The mount 26 slides along the length of the rail 38, e.g. along the length of the table 20, in a sliding direction, with the use of the wheels/bearings 74. When the mount 26 and attached saw 24 are properly positioned along the rail 38, the saw 24 is pivoted relative to the mount 26 and the blade 32 is used to cut the workpiece 22 mounted on the workpiece support rail 46 in a direction which is normal to the sliding direction.

A locking mechanism 86 is provided to lock the mount 26, and thus the saw 24, at the location of the desired cut on the workpiece 22. The locking mechanism 86 may take a variety of forms. As shown, the locking mechanism 86 is formed of a rotatable set screw threaded through a passageway 88 in the base 28 of the saw 24. To lock the locking mechanism 86, the set screw is turned until the end of the set screw engages with the slot 50 in the rail 38. While the base 28 of the saw 24 is shown as larger than the mount 26 and thus the locking mechanism 86 is shown engaged through the base 28, the mount 26 can be larger than the base 28 with the locking mechanism 86 extending through the mount 26, or the base 28 and mount 26 can be equally sized such that the locking mechanism 86 extends through both. After the mount 26 and saw 24 are locked into position, the operator turns on the saw 24 and engages the saw 24 to cut the workpiece 22.

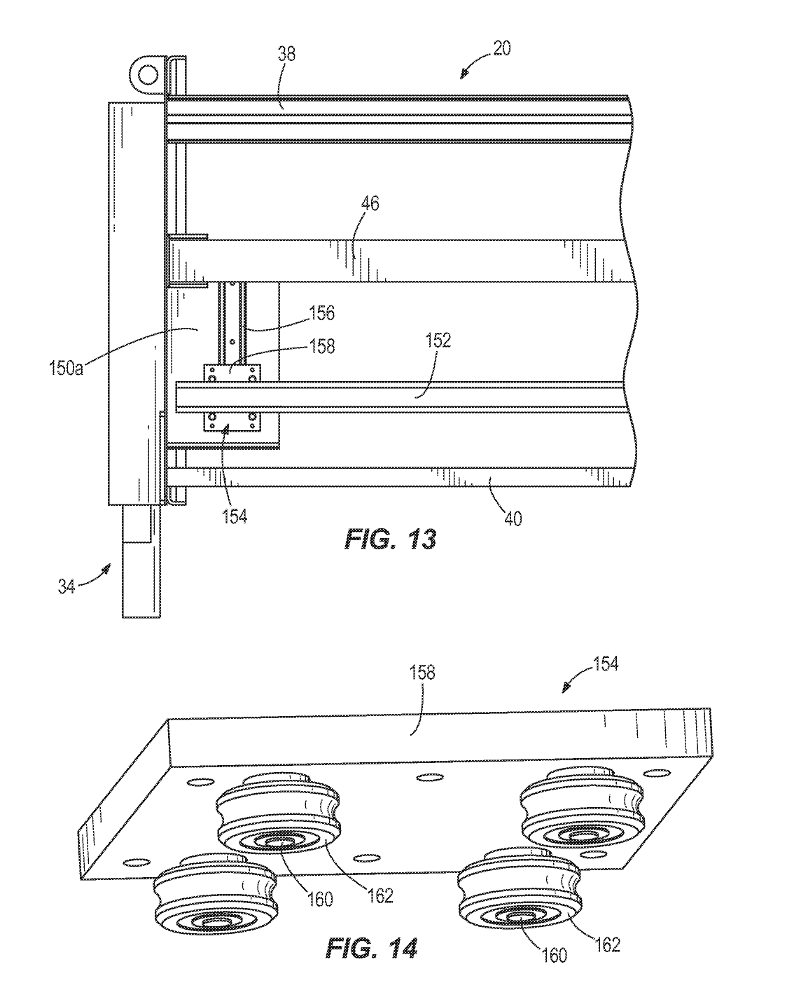

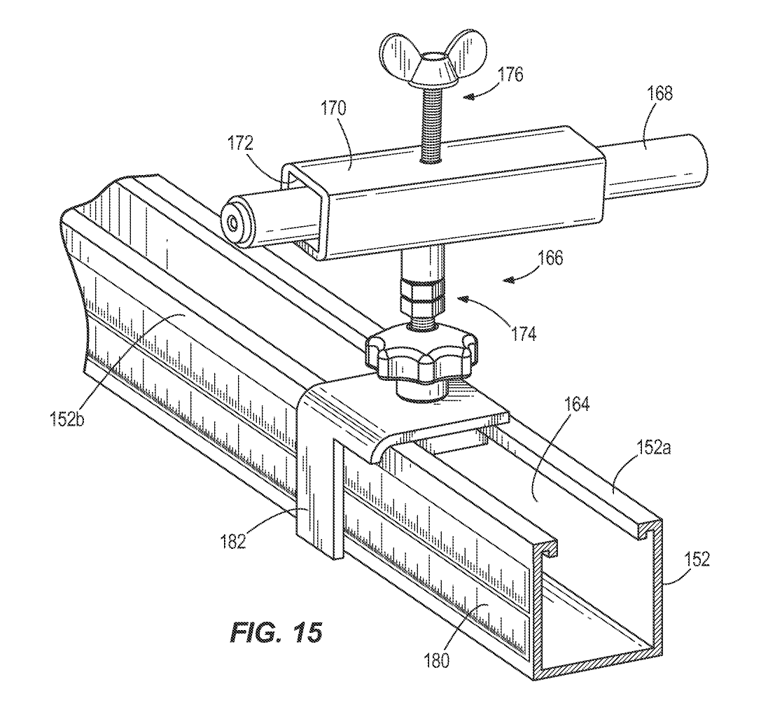

As best shown in FIGS. 12-15, the marking system 25 includes a pair of trays 150a, 150b which has an elongated rail 152 mounted therebetween by a pair of slideable platforms 154 which are mounted on tracks 156 on the trays 150a, 150b. Tray 150a extends horizontally from rib 44c on leg assembly 34 and tray 150b extends horizontally from 44c on leg assembly 36. The track 156 is mounted on an upper surface of each tray 150a, 150b and extends normal to the length of the rail 152. The respective platform 154 mounts on the respective track 156 and is slideable relative thereto. Each platform 154 has a base wall 158, a plurality of spindles 160 extending downwardly from the base wall 158, and a rotatable wheel 162 mounted on each spindle 160. The wheels 162 engage opposite side walls of the tracks 156. The ends of the rail 152 are affixed to the top of the respective base walls 158. When an operator pushes or pulls on the rail 152, the rail 152 translates toward or away from the workpiece support rail 46. The workpiece support rail 46 may also be mounted onto the trays 150a, 150b.

The rail 152 has an elongated slot 164 extending from its top surface 152a and which extends along the length of the rail 152.

The marking system 25 further includes a plurality of spaced apart marker holding brackets 166 which are mounted in the slot 164 and extend upwardly from the top surface 152a of the rail 152. A marker 168 may be mounted to each marker holding bracket 166 or to predetermined ones of the marker holding brackets 166. When mounted, the marker 168 is perpendicular to the rail 152. Each marker holding bracket 166 is formed of a tube 170 having a central passageway 172 into which the marker 168 is mounted, a mounting assembly 174 for mounting and locking the tube 170 to the rail 152, and a locking assembly 176 for locking the marker 168 to the tube 170.

The mounting assembly 176 may take a variety of forms and can be loosened to enable the marker holding bracket 166 to be moved along the rail 152 and can be tightened to secure the marker holding bracket 166 in place relative to the rail 152. The mounting assembly 176, when loosened, does not change the angular position of the tube 170 relative to the rail 152.

The locking mechanism 176 locks the marker 168 to the tube 170. The locking mechanism 176 may take a variety of forms. As shown, the locking mechanism 176 is formed of a rotatable set screw threaded through a passageway in a wall of the tube 170. To lock the locking mechanism 176, the set screw is turned until the end of the set screw engages with the marker 168 in the central passageway 172.

The marking system 25 further includes measurement markings 180, such as a tape measure, provided on a side wall 152b of the rail 152. The mounting assembly 176 includes a bracket 182 which overhangs the measurement markings 180 to enable the operator to correctly position the marker 168 at a desired location relative to the workpiece 22.

To use the table 20, the operator first mounts the workpiece 22 to be cut onto the workpiece holding brackets 48 with an end of the workpiece 22 abutting against the end wall 102 to prevent lateral movement of the workpiece 22 relative to the table 20. The table 20 can be lowered to a low position using the raising and lowering structure 104 in order for the operator to mount the workpiece 22 onto the workpiece holding brackets 48. The operator than loosens and slides the marker holding bracket(s) 166 to the positions where cuts or bends will be made on the workpiece 22. The marker holding bracket(s) 166 are properly positioned relative to the workpiece 22 using the measurement markings 180 and the bracket 180. Thereafter, the marker holding bracket(s) 166 are tightened to lock the markers 168 into position. The rail 152 is then slid toward the workpiece 22 until the markers 168 abut against the workpiece 22. When the markers 168 contact the workpiece 22, the markers 168 mark indicia on the workpiece 22. The workpiece 22 can be rotated relative to the workpiece holding bracket 48 such that a continuous indicia mark is formed around the workpiece 22. The rail 152 is then slid away from the workpiece 22.

Next, the saw 24 is translated laterally along the rail 38 until the saw 24 is aligned with the marked indicia of the workpiece 22 where a cut is to be made. The saw 24 is then locked into place. Thereafter, the saw 24 is actuated and pivoted to make the cut in the workpiece 22 at the marked location. The saw 24 is then translated laterally along the rail 28 to the next location where a cut is to be made.

As a result of the structure of the present invention, the table 20 can be used in a location where there is limited space on either end of the table 20. Since the saw 24 moves laterally relative to the table 20 and laterally relative to the workpiece 22, the workpiece 22 is held stationary and thus does not need to be moved to overhang the table 20 to a great extent.

While the protrusions 42 are shown on the mount 26 and the grooves 68, 82 on the wheels/bearings 74 and slide pads 70, 84, it is to be understood that the grooves may be provided on the mount 26 and the protrusions on the wheels/bearings and slide pads 70, 84.

While a preferred embodiment of the present invention is shown and described, it is envisioned that those skilled in the art may devise various modifications of the present invention without departing from the spirit and scope of the appended claims.

What is claimed is:

1. An assembly comprising:
a table having a first elongated rail having a predetermined length defining a length of the table which is greater than a width of said table;
a saw for cutting an associated workpiece, said saw having a blade extending in a direction which is normal to the length of the first rail; and
a mount, said saw mounted to said mount, said mount attached to said first rail and capable of translating along said first rail in a direction parallel to said length of said first rail.

2. The assembly of claim 1, wherein said saw is pivotable relative to said mount and said first rail.

3. The assembly of claim 1, wherein said mount has a plurality of rotatable wheels or bearings mounted thereto, said wheels or bearings engaged with said first rail.

4. The assembly of claim 3, wherein one of said first rail and said wheels or bearings has a protrusion extending therefrom which engages within a groove in the other of said first rail and said wheels or bearings.

5. The assembly of claim 1, further including a locking mechanism attached to at least one of said saw or said mount which engages with said first rail to fix the position of the mount and saw in place relative to the first rail.

6. The assembly of claim 1, further including an elongated recess along a top surface of said first rail, wherein said locking mechanism engages with said recess to fix the position of the mount in place relative to the first rail.

7. The assembly of claim 1, further including non-rotatable slide pads attached to said mount which engage with said first rail.

8. The assembly of claim 1, wherein said table include structure for raising and lowering a top portion of the table relative to a stationary surface to which the table is mounted.

9. The assembly of claim 1, further including a second rail mounted on said table, a marker slideably mounted on said second rail for making a mark on the associated workpiece.

10. The assembly of claim 9, wherein said second rail is moveable toward and away from said first rail.

11. An assembly comprising:
a workpiece having a predetermined length and a predetermined width, said length being greater than said length, said workpiece being stationary in position;
a table having a first elongated rail having a predetermined length defining a length of the table which is greater than a width of said table;
a pivoting saw for cutting an associated workpiece, said saw having a blade extending in a direction which is normal to the length of the first rail;
a mount having a plurality of rotatable wheels or bearing mounted thereon, each wheel or bearing engaging a side surface of said first rail, said saw mounted to said mount, said mount capable of translating along said first rail in a direction parallel to said length of said first rail and parallel to said length of said workpiece; and
a locking mechanism attached to at least one of said saw or said mount which engages with said first rail to fix the position of the mount and saw in place relative to the first rail and relative to the workpiece.

12. The assembly of claim 11, wherein one of said first rail and said wheels or bearings has a protrusion extending therefrom which engages within a groove in the other of said first rail and said wheels or bearings.

13. The assembly of claim 11, further including an elongated recess along a top surface of said first rail, wherein said locking mechanism engages with said recess to fix the position of the mount in place relative to the first rail.

14. The assembly of claim 11, further including slide blocks attached to said mount which engage with said first rail, wherein one of said first rail and said slide blocks has a protrusion extending therefrom which engages within a groove in the other of said first rail and said slide blocks.

15. The assembly of claim 11, wherein said table include structure for raising and lowering a top portion of the table relative to a stationary surface to which the table is mounted.

16. The assembly of claim 11, further including a second rail mounted on said table, a marker slideably mounted on said second rail for making a mark on the associated workpiece.

17. The assembly of claim 11, wherein said second rail is moveable toward and away from said first rail.

18. A method of cutting a workpiece comprising:
providing a workpiece having a predetermined length and width, said length being greater than said width;
holding the workpiece stationary;
sliding the saw along the length of the stationary workpiece in a sliding direction to a desired location; and
cutting the workpiece, wherein the cutting direction is normal to the sliding direction and the sliding direction is parallel to the workpiece lengthwise.

19. The method of claim 18, wherein said workpiece is marked with cutting locations prior to being cut.
